(19) United States
(12) Patent Application Publication
(10) Pub. No.: US 2022/0327023 A1
(43) Pub. Date: Oct. 13, 2022

(54) MIGRATION SUPPORT METHOD AND SYSTEM

(71) Applicant: Hitachi, Ltd., Tokyo (JP)

(72) Inventors: Shoichiro HORIBA, Tokyo (JP); Yoshihito AKIMOTO, Tokyo (JP); Hiroshi SUZUKI, Tokyo (JP); Chieko AKIBA, Tokyo (JP)

(73) Assignee: Hitachi, Ltd., Tokyo (JP)

(21) Appl. No.: 17/688,204

(22) Filed: Mar. 7, 2022

(30) Foreign Application Priority Data
Apr. 13, 2021 (JP) 2021-067737

(51) Int. Cl. G06F 11/14; G06F 11/07; G06F 9/48

(52) U.S. Cl. CPC G06F 11/1407; G06F 11/0793; G06F 11/1471; G06F 9/4875

(57) ABSTRACT

As a function equivalent to a first check point restart (CPR) section (CPR function) of a mainframe system, a second CPR section is implemented in an open system. When the mainframe system executes each of job steps that form a job to be migrated from the mainframe system to the open system, the first CPR section outputs a job journal, and when the open system executes the job step migrated from the mainframe system, the second CPR section outputs a job journal, followed by comparison between the outputted job journals.

### CROSS-REFERENCE TO PRIOR APPLICATION

This application relates to and claims the benefit of priority from Japanese Patent Application number 2021-67737, filed on Apr. 13, 2021 the entire disclosure of which is incorporated herein by reference.

### BACKGROUND

The present invention generally relates to a technology for migration support.

There is a known technology of related art for migration of a computer program from a mainframe system to an open system (Patent Literature 1, for example).

Patent Literature 1: Japanese Patent Laid-Open No. 2019-109584

### SUMMARY

There is a case where the target of the migration from a mainframe system to an open system is a job, such as a batch job. Once the migration is complete, it is desirable to make the mainframe system, which is the source of the migration, unnecessary (remove mainframe system, for example) to reduce the hardware operation cost.

To complete the migration of the job, it is necessary to verify that the migrated job operates correctly in the open system. The job verification takes a long time depending on the scale of the job (the number of job steps that form the job, for example) and the time required to execute the job steps contained in the job (for example, the verification takes a long time for a job formed of a large number of job steps, such as thousands to tens of thousands of job steps, or a job containing a job step executed for a long time). An abnormal end of a job step or inconsistency in the final result of the execution causes reverification of the entire job from the beginning, resulting in large overhead. The large overhead delays the completion of the job migration, resulting in an increase in the period for which the mainframe system cannot be made unnecessary.

As a function equivalent to a first check point restart (CPR) section (CPR function) of the mainframe system, a second CPR section is implemented in the open system. When the mainframe system executes each of job steps that form a job to be migrated from the mainframe system to the open system, the first CPR section outputs a job journal, and when the open system executes the job step migrated from the mainframe system, the second CPR section outputs a job journal, followed by comparison between the outputted job journals.

The present invention can eliminate the need for the reverification of a migrated job from the beginning.

### BRIEF DESCRIPTION OF THE DRAWINGS

FIG. 1 shows an example of the configuration of an entire system including a job migration support system according to a first embodiment;

FIG. 2 shows an example of the configurations of a current-new comparison management table and job journals;

FIG. 3 shows an example of the configuration of the system according to the first embodiment;

FIG. 4 shows an example of the procedure of a job execution control process carried out by a mainframe system;

FIG. 5 shows an example of the procedure of a current-new comparison verification process carried out by the mainframe system;

FIG. 6 shows part of an example of the procedure of a job execution control process carried out by an open system;

FIG. 7 shows the remainder of the example of the procedure of the job execution control process carried out by the open system;

FIG. 8 shows an example of the procedure of a state restoration process carried out by the open system;

FIG. 9 shows an example of the procedure of a dataset reconstruction process carried out by the open system;

FIG. 10 shows an example of the procedure of a state construction process carried out by the open system;

FIG. 11 shows an example of the procedure of a repaired program registration process carried out by the open system; and

FIG. 12 shows an example of the procedure of program repair.

### DESCRIPTION OF EMBODIMENTS

In the following description, the “interface apparatus” may be one or more interface devices. The one or more interface devices may be at least one of the following devices:
One or more I/O (input/output) interface devices. The I/O (input/output) interface devices are each an interface device for at least one of an I/O device and a remote computer for display purposes. The I/O interface device for the computer for display purposes may be a communication interface device. The at least one I/O device may be a user interface device, for example, any of an input device, such as a keyboard and a pointing device, and an output device, such as a display device.
One or more communication interface devices. The one or more communication interface devices may be one or more communication interface devices of the same kind (one or more network Interface cards (NICs), for example) or two or more communication interface devices of different kinds (NIC and HBA (host bus adapter), for example).

In the following description, the “memory” is one or more memory devices that are an example of one or more storage devices, and may typically be a primary storage device. The at least one memory device in the memory may be a volatile memory device or a nonvolatile memory device.

In the following description, the “permanent storage apparatus” may be one or more permanent storage devices that are an example of the one or more storage devices. The permanent storage devices may each typically be a nonvolatile storage device (auxiliary storage device, for example), specifically, for example, a hard disk drive (HDD), a solid state drive (SSD), a nonvolatile memory express (NVME) drive, or a storage class memory (SCM).

In the following description, the “storage apparatus” may be a memory and a permanent storage apparatus, at least a memory.

In the following description, the “processor” may be one or more processor devices. The at least one processor device may typically be a microprocessor device, such as a CPU (central processing unit), and may instead be another type of processor device, such as a GPU (graphics processing unit). The at least one processor device may be a single-core or multi-core device. The at least one processor device may be a processor core device. The at least one processor device may be a processor device in a broad sense, such as a circuit that is a collection of gate arrays that perform part or entirety of a process by using a hardware description language (for example, field-programmable gate array (FPGA), complex programmable logic device (CPLD), or application specific integrated circuit (ASIC)).

In the following description, a function is described by the expression of “section yyy”, and the function may be achieved by a processor through execution of one or more computer programs, may be achieved by one or more hardware circuits (FPGA or ASIC, for example), or may be achieved by a combination thereof. When a function is achieved by a processor through execution of a program, a specified process is carried out by using, for example, a storage apparatus and/or an interface apparatus as appropriate, so that the function may be at least part of the processor. A process described with a function used as the subject may be a process carried out by a processor or an apparatus including the processor. The program may be installed from a program source. The program source may, for example, be a program distribution computer or a computer-readable recording medium (non-transitory recording medium, for example). The description of each function is made by way of example, and a plurality of functions may be combined into one function, or one function may be divided into a plurality of functions.

In the following description, information that allows an input to provide an output is described in some cases by an expression, such as a “table xxx”, and the information may be data having any structure (may, for example, be structured data or unstructured data), a neural network that allows an input to generate an output, or a learning model represented by a genetic algorithm or a random forest. The “table xxx” can therefore be referred to as “information xxx”. In the following description, the configuration of each table is presented by way of example, and one table may be divided into two or more tables, or entirety or part of two or more tables may be integrated into one table.

In the following description, a name is employed as “identification information” that identifies each element, and another kind of information (ID, for example) may instead be employed in place of or in addition to the name.

In the following description, when elements of the same kind are not distinguished from one another in the description thereof, a common character out of the reference characters is used in some cases, and when the elements of the same kinds are distinguished from one another in the description thereof, the reference characters are used in some cases. In the following description, an element XX having a name “xxx” is referred to as ‘XX “xxx”’ in some cases in place of or in addition to the reference character of the element.

In the following description, the “dataset” is a logical electronic data block seen from a program, such as an application program, and may, for example, be any of a record, a file, a key value pair, and a tuple.

Several embodiments will be described below.

### First Embodiment

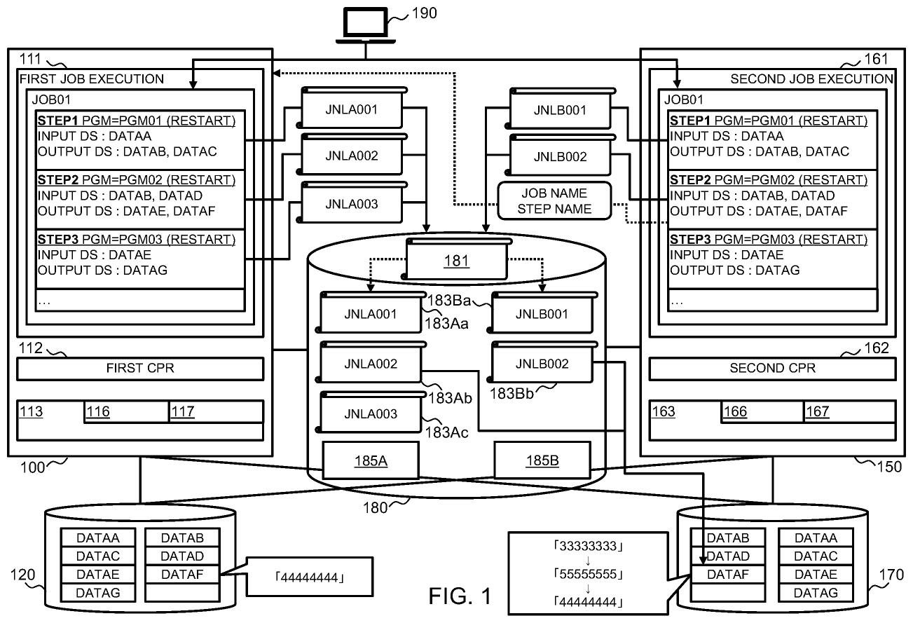

FIG. 1 shows an example of the configuration of an entire system including a migration support system according to a first embodiment. In the description shown in FIG. 1, a job “JOB01” exemplifies a job to be migrated.

The job “JOB01” is migrated from a mainframe system 100 to an open system 150. The job “JOB01” is formed of a plurality of job steps. One or more computer programs are associated with the job steps. In the present embodiment, a job step may be associated with a computer program in a one-to-one correspondence. The plurality of job steps are executed in a sequential order in the present embodiment. Instead, part of or two or more of the plurality of job steps may be executed at the same stage.

To complete the migration of the job “JOB01” from the mainframe system 100 to the open system 150, it is necessary to verify the job “JOB01” migrated to the open system 150. In the following description, the plurality of job steps that form the job “JOB01” in the mainframe system 100 (example of first job) are each referred to as a “first job step”, and the plurality of job steps that form the job “JOB01” in the open system 150 (example of second job) are each referred to as a “second job step” in some cases. The first job step and the second job step correspond to each other in a one-to-one correspondence. The second job step is the first job step migrated from the mainframe system 100 to the open system 150.

The mainframe system 100 includes a first job execution section 111, a first CPR (check point restart) section 112, and a first data management section 113. The first job execution section 111 executes the job “JOB01” on a first job step basis. The first CPR section 112 corresponds to the CPR function of the mainframe system 100. The first data management section 113 manages a dataset inputted to and outputted from the mainframe system 100. The first data management section 113 includes a first current-new comparison section 116 and a first data conversion section 117. The first current-new comparison section 116 and the first data conversion section 117 will be described later in detail. The first current-new comparison section 116 may be provided in the open system 150 in place of the mainframe system 100. One of the first data conversion section 117 and a second data conversion section 167, which will be described later, may be omitted.

The open system 150 includes a second job execution section 161, a second CPR section 162, and a second data management section 163. The second job execution section 161 executes the job “JOB01” on a second job step basis. The second CPR section 162 is a function equivalent to the CPR function. That is, the function equivalent to the CPR function is implemented in the open system 150 in the present embodiment. The second data management section 163 manages a dataset inputted to and outputted from the open system 150. The second data management section 163 includes a second current-new comparison section 166 and the second data conversion section 167. The second current-new comparison section 166 and the second data conversion section 167 will be described later in detail.

A console 190 (computer as input/output apparatus, for example) is coupled to the mainframe system 100 and the open system 150. The console 190 may be notified of a failed second job step in the migration. A repaired second job step may be inputted via the console 190.

The mainframe system 100 and the open system 150 are provided with volumes 120, 170, and 180. The “Volume” is an abbreviation for a logical volume (example of storage space).

The volume 120 is a volume for storing a dataset that is inputted or outputted in the execution of the job “JOB01” in the mainframe system 100. The volume 120 may be a volume that is accessible to the mainframe system 100 but is not accessible to the open system 150.

The volume 170 is a volume for storing a dataset that is inputted or outputted in the execution of the job “JOB01” in the open system 150. The volume 170 may be a volume that is accessible to the open system 150 but is not accessible to the mainframe system 100.

The volume 180 is an example of a storage space shared by the mainframe system 100 and the open system 150. In the following description, the “volume 180” is referred to as a “shared disk 180” for convenience. The shared disk 180 is configured to store a current-new comparison management table 181, a job journal 183A for the mainframe system 100, a job journal 183B for the open system 150, a memory register management table 185A of the mainframe system 100, and a memory register management table 185B of the open system 150. The memory register management table 185 stores memory register information (information containing memory information and register information). Out of the job journal 183 and the memory register management table 185, at least the job journal 183 may be stored in a storage space other than the shared disk 180. For example, the job journal 183A may be stored in the volume 120, and the job journal 183B of the second job step may be stored in the volume 170.

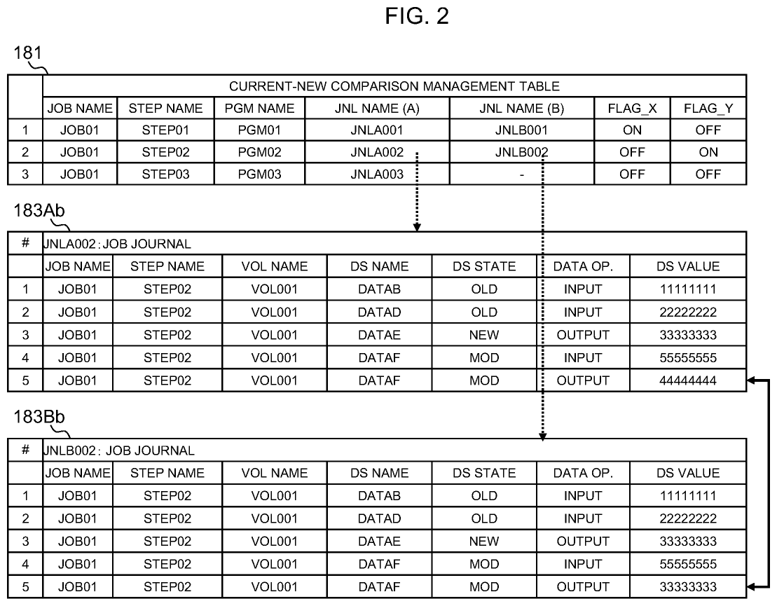

The current-new comparison management table 181 has an entry on a job step pair basis, as illustrated in FIG. 2. Each entry contains the information below. In the present embodiment, the “job step pair” is, out of the pairs of the first job step and the second job step, particularly, a pair of the first job step and the second job step in each of which a restart is specified (typically, “RESTART” is specified in RD operand)
Job name: The name of a job having the job step to which the job step pair belongs.
Step name: The name of the job step to which the job step pair belongs.
PGM name: The name of a program associated with the job step to which the job step pair belongs.
Journal name (A): The name of the job journal for a first job step to which the job step pair belongs.
Journal name (B): The name of the job journal for a second job step to which the job step pair belongs.
Match determination flag (“FLAG_X” in the figures): A flag indicating whether or not current-new match determination has been performed (example of match determination information). “ON” is an example of a value meaning that the current new match determination has been performed, and “OFF” is an example of a value meaning that the current-new match determination has not been performed.
Repair flag (“FLAG_Y” in the figures): a flag indicting whether or not the second job steps that belong to the job step pair need to be repaired (example of repair information). “ON” is an example of a value meaning that the repair is required, and “OFF” is an example of a value meaning that no repair is required.

The job journal 183 is a journal for each job step in which a restart is specified. The job journal 183A is the job journal for the first job step, and the job journal 183B is the job journal for the second job step. The job journal 183 has an entry for each dataset under data manipulation (input and output, for example) performed when the job step is executed, as illustrated in FIG. 2. Each entry contains the information below.
Job name: The name of the job having the job step.
Step name: The name of the job step.
VOL name: The name of the volume that stores the dataset.
DS name: The name of the dataset.
DS state: The state of the dataset. The DS state has, for example, values “MOD”, “OLD”, “NEW”, and “SHR”. “MOD” means an extension of the dataset (additional writing, for example). “OLD” means that the dataset has already existed before the start of the job step. “NEW” means that the dataset is a dataset created when the job step is executed. “SHR” means that the dataset has existed before the start of the job step and is shared by other job (used simultaneously, for example).
Data manipulation: Data manipulation to be performed on the dataset.
DS value: The value of the dataset.

An example of processes carried out in the present embodiment will be described below. It is assumed in the present embodiment that a character code interpretable by the open system 150 is also interpretable by the mainframe system 100. Furthermore, in the present embodiment, character code conversion, which is conversion of a character code interpretable by the mainframe system 100 into a character code interpretable by the open system 150, is performed as required by at least one of the first data conversion section 117 and the second data conversion section 167.

A duplicate of data referred to by the job “JOB01” in the mainframe system 100 is inputted to the open system 150, and the job “JOB01” in the mainframe system 100 and the job “JOB01” in the open system 150 are executed in parallel to each other. In the present embodiment, the mainframe system 100 is an example of an actually used system, and data inputted to the job “JOB01” in the mainframe system 100 is an example of actually used data. The open system 150 is an example of a verification system, and data (duplicate of actually used data) inputted to the job “JOB01” in the open system 150 is an example of dummy data (verification data).

### <1-1. Execution of Job Step in Mainframe System 100>

When a first job step to be executed is a first job step “STEP02”, which is an example of the first job step in which “RESTART” is specified in the RD operand, the following processes are carried out.
(1) The first CPR section 112 saves a job journal 183Ab “JNLA002” on the first job step “STEP02” and the memory register information at the start of the first job step “STEP02” in the memory register management table 185A in the shared disk 180, and waits for the start of the first job step “STEP02”. In the present specification, the “memory register” may be at least one of a memory and a register, and the memory register information is information containing at least part of the information stored in the memory register. For example, the memory register may store the address of other program corresponding to the job step being executed, data or a parameter necessary for execution of the job step, a pointer to the data or the parameter, a temporarily saved input value, a pointer to the input value, and other pieces of information, and the memory register information may contain at least part of the aforementioned information stored in the memory register. The data necessary for the start of the job step can be recovered and acquired by tracing the information along the pointer in the memory register information when the job step is restarted after the state is restored.
(2) The first CPR section 112 records the job name “JOB01”, the step name “STEP02”, and the journal name (A) “JNLA002” for the first job step in the current-new comparison management table 181 in the shared disk 180, and sets the match determination flag at “OFF” and the repair flag at “OFF”.
(3) When the mainframe system 100 (first current-new comparison section 116, for example) is notified of the start of execution of the second job step “STEP02” in the open system 150, the first job execution section 111 starts executing the first job step “STEP02”. The job step “STEP02” is thus executed in parallel by the mainframe system 100 and the open system 150. With the execution of the first job step “STEP02”, a dataset is outputted to the volume 120, and the job journal 183Ab is updated (see FIG. 2).

### <1-2. Execution of Job Step in Open System 150>

When the second job step to be executed is the second job step “STEP02”, which is the job step that is the migrated first job step “STEP02”, the second job step “STEP02” also has a RD operand, as in the mainframe system 100, and “RESTART” is specified in the RD operand. When such a second job step “STEP02” is the job step to be executed, the following processes are carried out:
(1) The second current-new comparison section 166 refers to the current-new comparison management table 181 in the shared disk 180, and determines whether or not the repair flag corresponding to the second job step “STEP02” is “OFF”.
(2) When the repair flag is “OFF”, the execution of the second job step “STEP02” is initiated. Specifically, since the second CPR section 162 is implemented, the second CPR section 162 acquires a job journal 183Bb “JNLB002” for the second job step “STEP02” and saves the memory register information in the memory register management table 185B in the shared disk 180. The second current-new comparison section 166 transmits a notification that notifies the start of execution of the second job step “STEP02” (notification containing job name and step name of second job step “STEP02”, for example) to the mainframe system 100. With the execution of the second job step “STEP02”, a dataset is outputted to the volume 170 (volume different from volume 120 that stores actually used dataset), and the job journal 183Bb is updated (see FIG. 2).
(3) When the execution of the second job step “STEP02” is completed, the second current-new comparison section 166 refers to the current-new comparison management table 181 in the shared disk 180, and when the match determination flag corresponding to the second job step “STEP02” is “OFF”, and the value of the JNL name (A) corresponding to the second job step “STEP02” is recorded (that is, when there is job journal for first job step “STEP02”), the second current-new comparison section 166 transmits a current-new comparison instruction (instruction for current-new comparison verification) to the first current-new comparison section 116. For example, the job name “JOB01” and the step name “STEP02” are associated with the current-new comparison instruction.

### <2. Current-New Comparison Verification>

The first current-new comparison section 116 carries out the following processes in response to the current-new comparison instruction from the open system 150.
(1) The first current-new comparison section 116 uses the current-new comparison management table 181 to identify the journal name (A) “JNLA002” and the journal name (B) “JNLB002” corresponding to the job name “JOB01” and the step name “STEP02”.
(2) The first current-new comparison section 116 performs current-new match determination, which is determination of whether or not the job journal 183Ab having the journal name (A) “JNLA002” and the job journal 183Bb having the journal name (B) “JNLB002” match each other. Specifically, sequentially from the first entry of the job journal 183Ab and the first entry of the job journal 183Bb, it is determined whether or not the corresponding entries match each other.
   <2-1. Case where Result of Current-New Match Determination is True>

When all the entries of the job journal 183Ab and all the entries of the job journal 183Bb match each other, the result of the current-new match determination is true. In this case, the following processes are carried out:
(1) The first current-new comparison section 116 changes the match determination flag corresponding to the job name “JOB01” and the step name “STEP02” to “ON”.
(2) The first current-new comparison section 116 deletes the job journal 183Ab and the job journal 183Bb corresponding to the job name “JOB01” and the step name “STEP02” from the shared disk 180.

The mainframe system 100 and the open system 150 then start executing the following job step “STEP03”. Execution of the following first job step “STEP03” in the mainframe system 100 has been described in <1-1. Execution of job step in mainframe system 100>, and the execution of the following second job step “STEP03” in the open system 150 has been described in <1-2. Execution of job step in open system 150>.

<2-2. Case where Result of Current-New Match Determination is False>

When there is even one non-matching entry between the job journal 183Ab and the job journal 183Bb, the result of the current-new match determination is false. According to the example shown in FIG. 2, the dataset value “44444444” in the last entry of the job journal 183Ab and the dataset value “33333333” in the last entry of the job journal 183Bb differ from each other and therefore do not match each other, so that the result of the current-new match determination is false. In this case, the following processes are carried out. Out of the following processes, (1) to (3) are processes of restoring the state at the start of the failed second job step “STEP02”, and (4) and (5) are processes of constructing the state at the start of the second job step “STEP03” following the failed second job step “STEP02” (in other words, the state at the time when the second job step “STEP02” is normally completed).
(1) The first current-new comparison section 116 outputs a notification indicating an abnormal end of the job step “STEP02” to the console 190, and changes the repair flag corresponding to the job name “JOB01” and the step name “STEP02” to “ON”. The console 190 having received the notification can display information representing the content of the notification (abnormal end of job step “STEP02”). A user who sees the information can grasp the abnormality of the second job step “STEP02”. The user can repair the program associated with the second job step “STEP02”.
(2) The second current-new comparison section 166 transmits a notification indicating the job name “JOB01” and the step name “STEP02” of the job step having failed to be executed to the open system 150.
(3) In response to the notification, the second CPR section 162 refers to the job journal 183Bb, maintains (leaves) the dataset in the DS state “MOD”, “OLD”, or “SHR” in the volume 170, and deletes the dataset in the DS state “NEW” (or not specified) from the volume 170. The second CPR section 162 restores the dataset in the state immediately before the start of the second job step “STEP02” based on the job journal 183Bb and the maintained dataset (according to the examples shown in FIGS. 1 and 2, for example, the value “33333333” of the dataset “DATAF” is restored to “55555555”). Furthermore, the second CPR section 162 recovers the memory register information saved at the start of the second job step “STEP02” from the memory register management table 185B.
(4) The second CPR section 162 identifies, from the current-new comparison management table 181, a job journal 183Ac (and memory register information) at the start of the first job step “STEP03” for the first job step “STEP03” following the first job step “STEP02” corresponding to the failed second job step “STEP02”.
(5) The second CPR section 162 constructs a dataset in the state at the start of the second job step “STEP03” following the failed second job step “STEP02” (in other words, the state at the time when the second job step “STEP02” is normally completed) based on the job journal 183Ac (and memory register information) at the start of the first job step “STEP03” and the dataset in the restored state immediately before the start of the second job step “STEP02”. According to the example shown in FIGS. 1 and 2, for example, the restored value “55555555” of the dataset “DATAF” is constructed to “44444444”.

The mainframe system 100 and the open system 150 then start executing the following job step “STEP03”.

### <3. Repair and Reflection of Second Job Step (Program)>

The user of the console 190 repairs the program of the notified failed second job step “STEP02”, and registers the repaired program in the open system 150.

When the repaired program is registered in the open system 150, the second current-new comparison section 166 changes the repair flag corresponding to a target PGM name (name of repaired program) in the current-new comparison management table 181 to “OFF”.

After the processes described above, when the match determination flags and the repair flags of all the entries in the current-new comparison management table 181 are “ON” and “OFF”, respectively, the migration is completed, whereby the mainframe system 100 (and permanent storage apparatus for mainframe system 100, on which volume 120 is based) can be removed.

The present embodiment will be described below in more detail.

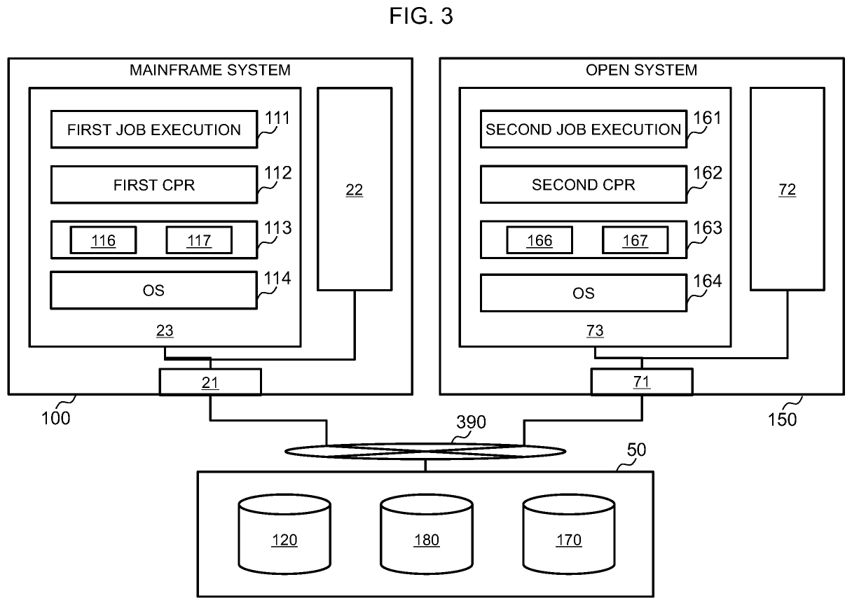

FIG. 3 shows an example of the configuration of the system according to the first embodiment.

The mainframe system 100, the open system 150, and an external storage apparatus 50 are coupled to a network 390. The network 390 is, for example, a WAN (wide area network) or a LAN (local area network).

The mainframe system 100 is a computer system (one or more computers) and includes an interface apparatus 21, a storage apparatus 22, and a processor 23 coupled to the interface apparatus 21 and the storage apparatus 22. The interface apparatus 21 is coupled to the network 390. The storage apparatus 22 includes a memory. The processor 23 executes an OS (operating system) 114 and other pieces of software. Executing the OS 114 and the other pieces of software achieves the first job execution section 111, the first CPR section 112, the first data management section 113 (first current-new comparison section 116 and first data conversion section 117), and other functions.

The open system 150 is a computer system (one or more computers) and includes an interface apparatus 71, a storage apparatus 72, and a processor 73 coupled to the interface apparatus 71 and the storage apparatus 72. The interface apparatus 71 is coupled to the network 390. The storage apparatus 72 includes a memory. The processor 73 executes an OS 164 and other pieces of software. Executing the OS 164 and the other pieces of software achieves the second job execution section 161, the second CPR section 162, the second data management section 163 (second current-new comparison section 166 and second data conversion section 167), and other functions.

The external storage apparatus 50 is an apparatus that includes a permanent storage apparatus and provides the volumes 120, 170, and 180 based on the permanent storage apparatus. The volume 120 is accessible at least to the mainframe system 100, the volume 170 is accessible at least to the open system 150, and the volume 180 (shared disk 180) is accessible both to the mainframe system 100 and the open system 150. The volumes may each be provided, for example, in the form of a cloud computing service.

An example of the details of processes carried out in the present embodiment will be described below. In the description, the job “JOB01” exemplifies a job to be migrated. Data (actually used data) referred to by the job “JOB01” is inputted to the mainframe system 100, a duplicate (dummy data) of the data is inputted to the open system 150, and the job “JOB01” in the mainframe system 100 and the job “JOB01” in the open system 150 are executed in parallel to each other.

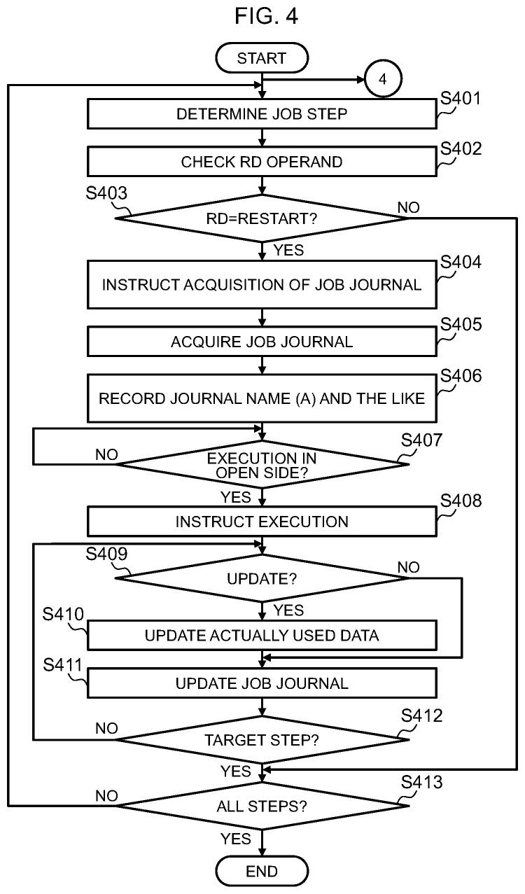

FIG. 4 shows an example of the procedure of a job execution control process carried out by the mainframe system 100.

The first job execution section 111 determines a first job step to be executed (S401). The job step determined in S401 is hereinafter referred to as a “target first job step” for convenience.

The first job execution section 111 checks the RD operand in the target first job step (S402). When the RD operand is not “RESTART” (NO in S403), the process proceeds to the process in S413.

When the RD operand is “RESTART” (YES in S403), the first job execution section 111 instructs the first CPR section 112 to acquire the job journal for the target first job step (S404). In response to the instruction, the first CPR section 112 acquires (stores) the job journal for the target first job step in the shared disk 180 (S405). Furthermore, the first CPR section 112 records the job name “JOB01”, the step name (name of target first job step), and the journal name (A) (name of the job journal) in the current-new comparison management table 181 (S406). In the target first job step, the current-new match flag is “OFF”, and the repair flag is also “OFF”.

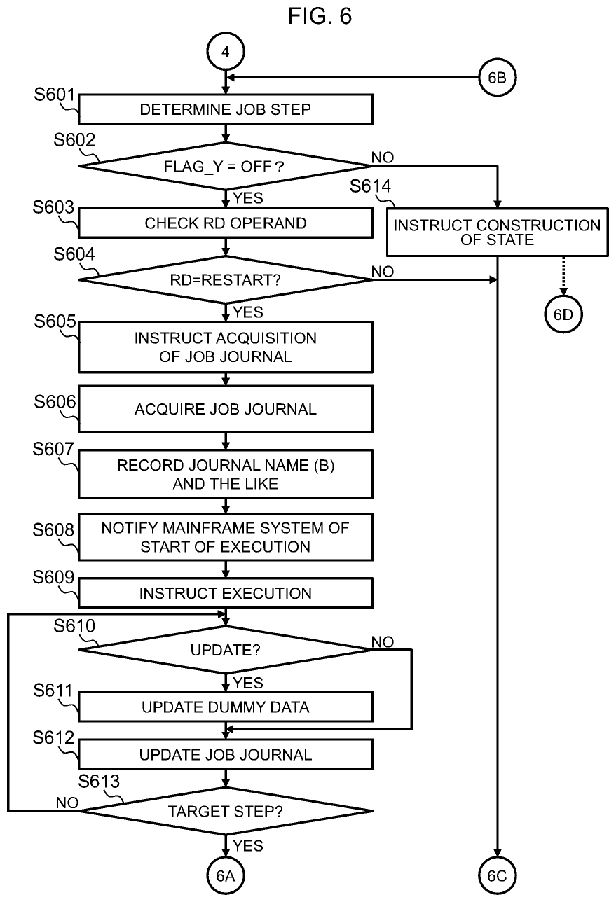

The first current-new comparison section 116 determines whether or not execution of a target second job step, which is the second job step corresponding to the target first job step (migrated target first job step) has been initiated (S407). The target first job step is not executed but is idle until the result of the determination in 5407 becomes true. The result of the determination in 5407 becomes true when a notification of the start of execution of the target second job step is received from the open system 150 (when 5608 in FIG. 6 is carried out on target second job step).

When the result of the determination in 5407 is true (YES in S407), the first job execution section 111 instructs the first job execution section 111 (that is, internally) to execute the target first job step (S408).

In response to the instruction, the first job execution section 111 executes the target first job step. With the execution, on a data manipulation basis, for example, when the data manipulation is “update” (YES in S409), the first job execution section 111 updates the actually used data (to be exact, dataset in actually used data) (S410), and the first CPR section 112 updates the job journal for the target first job step (S411). When the data manipulation is not “update” (NO in S409), S410 is skipped and S411 is carried out. As described above, on a data manipulation basis, an entry is present in the job journal for the target first job step. When the target first job step is not completed (NO in S412), S409 is carried out on the rest of the target first job step.

When the target first job step is completed (YES in S412), the first job execution section 111 determines whether or not the process in S401 and the following processes have been carried out on all the first job steps of the job “JOB01” (S413). When the result of the determination in S413 is false (NO in S413), S401 is carried out on the unprocessed first job steps. When the result of the determination in S413 is true (YES in S413), the overall procedure ends.

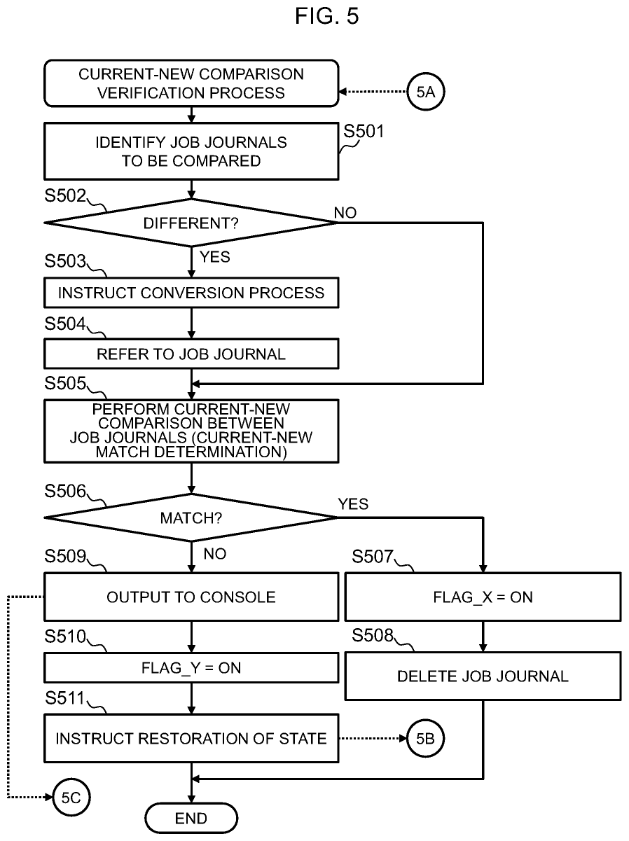

FIG. 5 shows an example of the procedure of a current-new comparison verification process carried out by the mainframe system 100.

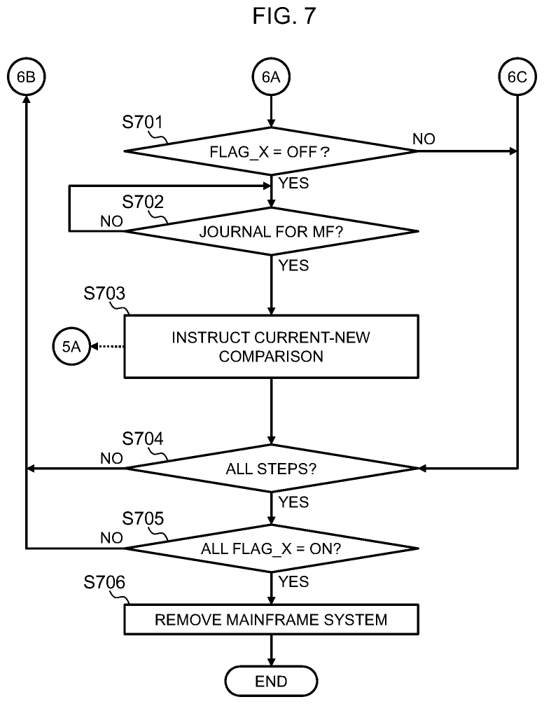

The first current-new comparison section 116 identifies the job journals 183A and 183B under comparison (S501). For example, the current-new comparison verification process is carried out in response to the current-new comparison instruction (instruction transmitted in S703 in FIG. 7) from the open system 150, and the job name and the step name are associated with the current-new comparison instruction. The first current-new comparison section 116 identifies the journal name (A) and the journal name (B) from the current-new comparison management table 181 by using the job name and the step name associated with the current-new comparison instruction as keys, and identifies the job journals 183A and 183B under comparison from the identified journal names (A) and (B).

The first current-new comparison section 116 determines whether or not the character codes or the like in the job journals 183A and 183B identified in S501 differ from each other (S502). When the result of the determination in S502 is true (YES in S502), the first current-new comparison section 116 instructs the first data conversion section 117 to carry out a conversion process (S503). In response to the instruction, the first data conversion section 117 converts the character code or the like in the job journal 183A into the character code or the like for the open system. The data save format, the character code, and the like may differ between the mainframe system 100 and the open system 150, but the first data conversion section 117 converts the character code and the like for the mainframe system 100 into the character code and the like for the open system 150. The first current-new comparison section 116 refers to the job journal 183A as a result of the conversion of the character code and the like (S504), and compares the job journal 183A with the job journal 183B. That is, the current-new match determination of whether or not the job journal 183A and the job journal 183B match each other is made (S505).

When the result of the current-new match determination is true (YES in S506), the first current-new comparison section 116 updates the match determination flags corresponding to the job journals 183A and 183B identified in S501 to “ON” (S507). The first current-new comparison section 116 deletes the job journals 183A and 183B identified in S501 from the shared disk 180 (S508).

When the result of the current-new match determination is false (NO in S506), the first current-new comparison section 116 outputs information on the failed second job step and corresponding to the job journal 183B identified in S501 (information containing job name and step name, for example) to the console 190 (S509). The first current-new comparison section 116 updates the repair flag corresponding to the failed second job step to “ON” (S510). The first current-new comparison section 116 transmits a state restoration instruction of restoring the state at the start of the failed second job step to the open system 150 (S511).

FIGS. 6 and 7 show an example of the procedure of a job execution control process carried out by the open system 150.

The second job execution section 161 determines a second job step to be executed (S601). It is assumed in the description that a target second job step that is the second job step corresponding to the target first job step has been determined.

The second job execution section 161 determines whether or not the repair flag corresponding to the target second job step is “OFF” (S602).

When the result of the determination in S602 is true (YES in S602), the second job execution section 161 checks the RD operand in the target second job step (S602). When the RD operand is not “RESTART” (NO in S604), the process proceeds to the process in S705.

When the RD operand is “RESTART” (YES in S604), the second job execution section 161 instructs the second CPR section 162 (that is, internally) to acquire the job journal for the target second job step (S605). In response to the instruction, the second CPR section 162 acquires (stores) the job journal for the target second job step in the shared disk 180 (S606). Furthermore, the second CPR section 162 records the job name “JOB01”, the step name (name of target second job step), and the journal name (B) (name of job journal) in the current-new comparison management table 181 (S607). The second current-new comparison section 166 transmits a notification of the start of execution of the target second job step (notification containing job name and step name of target second job step, for example) to the mainframe system 100 (S608). The second data management section 163 instructs the second job execution section 161 to execute the target second job step (S609).

In response to the instruction, the second job execution section 161 executes the target second job step. With the execution, on a data manipulation basis, for example, when the data manipulation is “update” (YES in S610), the second job execution section 161 updates the dummy data (to be exact, dataset in dummy data) (S611), and the second CPR section 162 updates the job journal for the target second job step (S612). When the data manipulation is not “update” (NO in S610), S611 is skipped and S612 is carried out. As described above, on a data manipulation basis, an entry is present in the job journal for the target second job step. When the target second job step is not completed (NO in S613), S610 is carried out on the rest of the target second job step.

When the target second job step is completed (YES in S613), the second current-new comparison section 166 determines whether or not the match determination flag corresponding to the target second job step is “OFF” (S701). When the result of the determination in S701 is false (NO in S701), the process proceeds to the process in S704.

When the result of the determination in S701 is true (YES in S701), the second current-new comparison section 166 determines whether or not the journal name (A) corresponding to the target second job step is present (whether or not job journal for target first job step is present) (S702). When the result of the determination in S702 is false (NO in S702), S702 is carried out again after a fixed period.

When the result of the determination in S702 is true (YES in S702), the second current-new comparison section 166 transmits the current-new comparison instruction (instruction associated with job name and step name corresponding to target second job step) to the mainframe system 100 (S703).

The second job execution section 161 determines whether or not the process in S601 and the following processes have been carried out on all the second job steps of the job “JOB01” (S704). When the result of the determination in S704 is false (NO in S704), S601 is carried out on the unprocessed second job steps.

When the result of the determination in S704 is true (YES in S704), the second data management section 163 (second current-new comparison section 166, for example) determines whether or not the match determination flags of all the entries in the current-new comparison management table 181 are “ON” (S705). When the result of the determination in S705 is false (NO in S705), the second data management section 163 returns to the process in S601. When the result of the determination in S705 is true (YES in S705), the mainframe system 100 may be removed (S706). For example, the second current-new comparison section 166 may output information representing completion of the migration to the console 190, and the user who has been informed of the completion of the migration may remove the mainframe system 100. The determination in S705 may be made by the mainframe system 100 (first current-new comparison section 116, for example) in place of the open system 150.

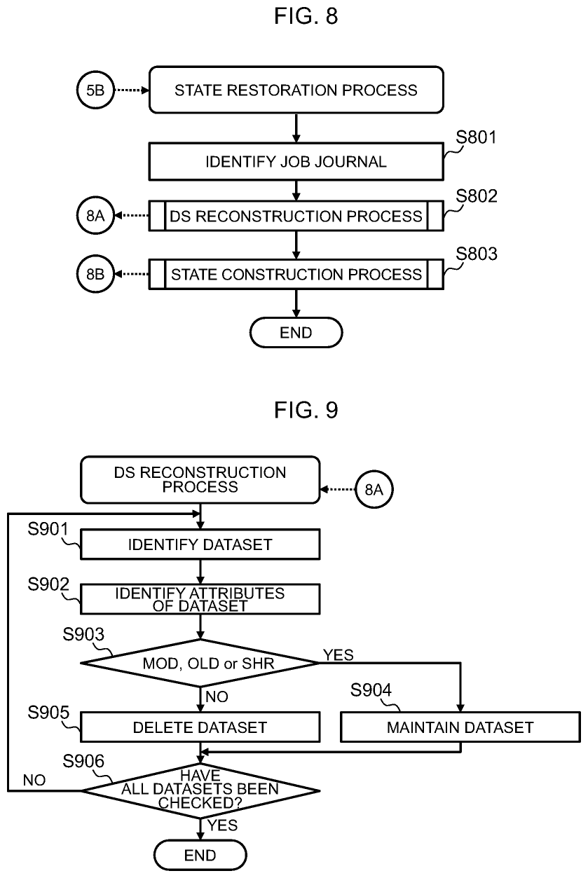

FIG. 8 shows an example of the procedure of a state restoration process carried out by the open system 150.

When the open system 150 receives the state restoration instruction transmitted in S511 in FIG. 5, the state restoration process is initiated. The state restoration instruction is associated with the job name and the step name of the failed second job step.

The second CPR section 162 identifies the failed second job step (under state restoration) from the state restoration instruction, and identifies the job journal for the identified second job step from the current-new comparison management table 181 (S801).

The second CPR section 162 carries out a dataset reconstruction process by using the job journal identified in S801 (S802). The second CPR section 162 then carries out a state construction process (S803).

FIG. 9 shows an example of the procedure of the dataset restoration process carried out by the open system 150.

The second CPR section 162 determines one dataset from the datasets for which S901 has not yet been carried out from the job journal identified in S801 (S901), and identifies the DS state of the determined dataset (S902).

The second CPR section 162 maintains the dataset determined in S901 (S904) when the DS state identified in S902 is “MOD”, “OLD”, or “SHR” (YES in S903). On the other hand, when the DS state identified in S902 is “NEW” (or not specified) (NO in S903), the second CPR section 162 deletes the dataset determined in S901 (S905).

The second CPR section 162 determines whether or not the process in S901 and the following processes have been carried out on all the datasets indicated by the job journal identified in S801 (S906). When the result of the determination in S906 is false (NO in S906), the second CPR section 162 returns to the process in S901. When the result of the determination in S906 is true (YES in S906), the dataset restoration process ends.

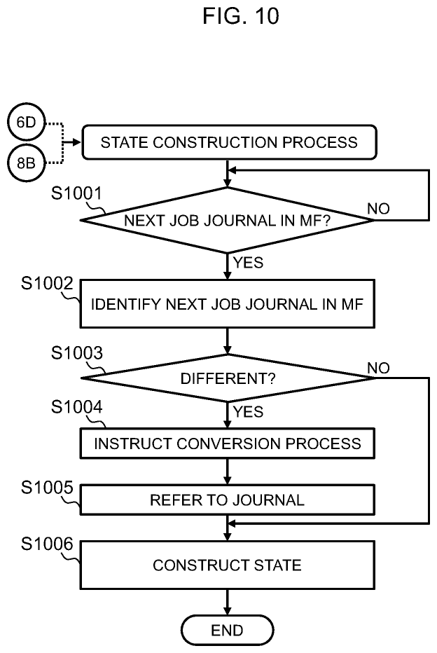

FIG. 10 shows an example of the procedure of the state construction process carried out by the open system 150.

The second CPR section 162 determines whether or not the mainframe system 100 has acquired the job journal for a first job step following the first job step corresponding to the failed second job step (whether or not there is value of journal name (A) corresponding to job step following failed second job step) (S1001).

When the result of the determination in S1001 is true (YES in S1001), the second CPR section 162 identifies the job journal 183A for the following first job step described above from the shared disk 180 (S1002). The second CPR section 162 determines whether or not the character code or the like in the job journal 183A identified in S1002 differs from the character code or the like in the job journal 183B in the open system 150 (S1003). When the result of the determination in S1003 is true (YES in S1003), the second CPR section 162 instructs the second data conversion section 167 to perform a conversion process (S1004). In response to the instruction, the second data conversion section 167 converts the character code or the like in the job journal 183A identified in S1002 into the character code or the like for the open system. The second CPR section 162 refers to the job journal 183A in which the character code or the like has been converted (job journal 183A identified in S1002) (S1005), and constructs a dataset in the state at the start of the second job step corresponding to the following first job step described above (state at the time when aforementioned failed second job step is normally completed) based on the job journal 183A and the state (dataset) at the start of the aforementioned failed second job step (S1006).

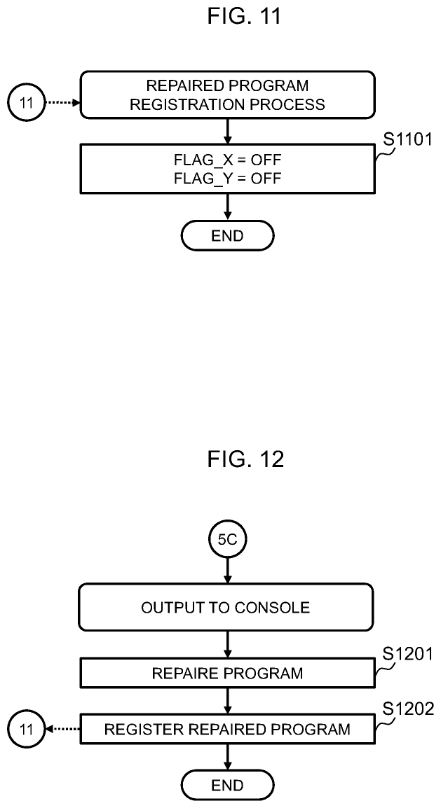

FIG. 11 shows an example of the procedure of a repaired program registration process carried out by the open system 150.

When the repaired program (program having been repaired) of the failed second job step is registered, the second data management section 163 (second current-new comparison section 166, for example) updates the match determination flag corresponding to the second job step to “OFF” and updates the repair flag corresponding to the second job step to “OFF” (S1101).

FIG. 12 shows an example of the procedure of the program repair.

The user who sees the information displayed on the console 190 (notification of failed second job step) repairs the program of the failed second job step (S1201), and registers the repaired program in the open system 150.

The first embodiment has been described above.

### Second Embodiment

A second embodiment will be described. In the description, differences from the first embodiment will be primarily described, and description of points common to the first embodiment will be omitted or simplified.

In the second embodiment, after the mainframe system 100 acquires the job journal 183A for all the first job steps, the open system 150 starts actual operation. That is, the open system 150 is an example of an actually used system in the second embodiment.

When the open system 150 fails to execute the second job step, the mainframe system 100 executes the first job step corresponding to the failed second job step. That is, when the open system 150 fails to execute a job step, the mainframe system 100 takes over the job step.

In the second embodiment, the current-new comparison verification process may be carried out by either the mainframe system 100 or the open system 150, but the mainframe system 100 may carry out the current-new comparison verification process to prioritize the actual operation of the open system 150.

Until the current-new match determination is completed on the job journal for the second job step, the open system 150 may wait for the start of execution of a second job step following the second job step.

The second embodiment has been described above.

The aforementioned description can, for example, be summarized as follows. It should be noted that the following summary may contain a supplement to the aforementioned description or a description of variations.

The migration support system includes a first current-new comparison section 116 and a second CPR section 162. The first current-new comparison section 116 may be provided in either the mainframe system 100 or the open system 150. The second CPR section 162 is a function equivalent to the first CPR section 112 (CPR function) of the mainframe system 100. For each of the first job steps that form the first job (job “JOB01”, for example), when restart is specified in the first job step (RD operand, for example), the mainframe system 100 is configured to output a job journal representing data manipulation in the first job step and a dataset on a data manipulation basis via the first CPR section 112. For each of the second job steps that form the second job (job “JOB01”, for example) that is the migrated first job, when restart is specified in the second job step, the second CPR section 162 outputs a job journal representing data manipulation in the second job step and a dataset on a data manipulation basis. The first current-new comparison section 116 performs the current-new match determination, which is the determination of whether or not the job journals for the first job step and the second job step coincide with each other, for each of the job step pairs that are pairs of the corresponding first job step and second job step in each of which restart is specified, and carries out a process according to the result of the current-new match determination.

Since the second CPR section 162 is provided in the open system 150, the open system 150 also outputs a job journal on a job step basis, as the mainframe system 100 does. In general, the job journal is used to recover the state (dataset) at the start of the job step. In the embodiment described above, however, the job journal is used to perform the current-new comparison verification of the input/output to and from the job step. Verification on a job step basis can thus be performed, eliminating the need for reverification of a migrated job from the beginning. As a result, the period required to complete the migration is short, whereby the cost of the mainframe system 100 can be reduced.

When the result of the current-new match determination is false (NO in S506 in FIG. 5), the process according to the result of the current-new match determination may contain notifying the second CPR section 162 of the failed second job step, which is a second job step that belongs to the job step pair. The second CPR section 162 may restore a dataset as the state before the start of the second job step based on a job journal for the failed second job step, as shown in FIG. 8. The state at the start of the failed second job step can thus be restored.

When the result of the current-new match determination is false (NO in S506 in FIG. 5), the second CPR section 162 may acquire a job journal at the start of a first job step following a first job step corresponding to the failed second job step, and construct a dataset as the state at the start of a second job step corresponding to the following first job step and following the failed second job step based on the acquired job journal and the restored dataset described above. The open system 150 may initiate the following second job step based on the constructed dataset. The failed job step is thus assumed to be normally completed, and the job can be resumed from the following job step.

Jobs may be executed in parallel in the mainframe system 100 and the open system 150, and on job step pair basis in the parallel execution, when the second current-new comparison section 166 acquires a job journal for a second job step that belongs to the job step pair, the second current-new comparison section 166 may notify the mainframe system 100 of the start of execution of the second job step (S608 in FIG. 6). The mainframe system 100 acquires a job journal for a first job step that belongs to the job step pair, waits for the start of the execution of the first job step, and may initiate the execution of the first job step that belongs to the job step pair when the mainframe system 100 receives notification of the start of the execution of the second job step (YES in S407 in FIG. 4). The current-new comparison verification checks that the same input causes output of the same result, but in the parallel job execution (that is, jobs remain running) in the mainframe system 100 and the open system 150, the migration can be completed for the job step for which the current-new match determination shows a match result, as in the first embodiment.

The storage space shared by the mainframe system 100 and the open system 150 (shared disk 180, for example) stores on a job step pair basis repair information (repair flag, for example), which is information representing whether or not the second job step that belongs to the job step pair needs to be repaired, and match determination information (match determination flag, for example), which is information representing whether or not the current-new match determination has been performed. Whether or not the current-new match determination has been completed for the job step pair and the result of the determination can thus be identified by referring to the shared storage space.

The following may be performed on a job step pair basis. The migration support can thus be performed based on the value of the match determination information or the value of the repair information.
When the value of the repair information is a value meaning that no repair is necessary (YES in S602 in FIG. 6), the open system 150 may execute the second job step.
When the value of the match determination information is a value meaning that the current-new match determination has not been performed (YES in S701 in FIG. 7), the first current-new comparison section 116 may perform the current-new match determination (S505 in FIG. 5), and update the value of the match determination information to a value meaning that the current-new match determination has been performed (S510 in FIG. 5).
When the result of the current-new match determination is false (NO in S506 in FIG. 5), the process according to the result of the current-new match determination may include notification to the console of the failed second job step (S509 in FIG. 5) and update of the value of the repair information to a value meaning that repair is necessary (S510 in FIG. 5).
When the failed second job step is repaired, the second current-new comparison section 166 may update the match determination information to a value meaning that the current-new match determination has not been performed, and update the value of the repair information to a value meaning that no repair is necessary (S1101 in FIG. 11).

When the result of the current-new match determination is true (YES in S506 in FIG. 5), the process according to the result of the current-new match determination may include deletion of a job journal for a first job step that belongs to the job step pair and a job journal for a second job step that belongs to the job step pair. The consumption (consumed storage capacity) of the volume 180 can thus be reduced.

Some embodiments have been described above, and the embodiments are examples for describing the present invention, and it is not intended that the scope of the present invention is limited only to the embodiments. The present invention can also be implemented in a variety of other forms.

What is claimed is:

1. A job migration support system comprising:
a first current-new comparison section provided in either a mainframe system that includes a first check point restart (CPR) section and executes a first job or an open system that executes a second job that is the first job migrated to the open system; and
a second CPR (check point restart) section provided in the open system,
wherein the first job is formed of a plurality of first job steps,
the second job is formed of a plurality of second job steps respectively corresponding to the plurality of first job steps,
for each of the first job steps, when restart is specified in the first job step, the mainframe system outputs a job journal representing data manipulation in the first job step and a dataset on a data manipulation basis via the first CPR section,
for each of the second job steps, when restart is specified in the second job step, the open system outputs a job journal representing data manipulation in the second job step and a dataset on a data manipulation basis via the second CPR section,
the first current-new comparison section, for each of job step pairs that are pairs of the corresponding first job step and second job step in each of which the restart is specified,
performs current-new match determination that is determination of whether or not the job journals for the first job step and the second job step coincide with each other and
carries out a process according to a result of the current-new match determination.

2. The job migration support system according to claim 1,
wherein when the result of the current-new match determination is false,
the process according to the result of the current-new match determination contains notifying the second CPR section of a failed second job step that is a second job step that belongs to the job step pair, and
the second CPR section restores a dataset as a state before start of the second job step based on a job journal for the failed second job step.

3. The job migration support system according to claim 2,
wherein when the result of the current-new match determination is false,
the second CPR section acquires a job journal at start of a first job step following a first job step corresponding to the failed second job step,
the second CPR section constructs a dataset as the state at start of a second job step corresponding to the following first job step and following the failed second job step based on the acquired job journal and the restored dataset, and
the open system initiates the following second job step based on the constructed dataset.

4. The job migration support system according to claim 3,
wherein the open system includes a second current-new comparison section,
when a duplicate of data that the first job refers to in the mainframe system is inputted in the open system and the first job in the mainframe system and the second job in the open system are executed in parallel, on a job step pair basis,
when the second current-new comparison section acquires a job journal for a second job step that belongs to the job step pair, the second current-new comparison section notifies the mainframe system of start of execution of the second job step,
the mainframe system acquires a job journal for a first job step that belongs to the job step pair and waits for start of the execution of the first job step, and
the mainframe system initiates execution of the first job step that belongs to the job step pair when the mainframe system receives notification of the start of execution of the second job step.

5. The job migration support system according to claim 1,
wherein a storage space shared by the mainframe system and the open system stores on a job step pair basis repair information that is information representing whether or not a second job step that belongs to the job step pair needs to be repaired, and match determination information that is information representing whether or not the current-new match determination has been performed.

6. The job migration support system according to claim 5,
wherein the open system includes a second current-new comparison section,
on job step pair basis,
when a value of the repair information is a value meaning that no repair is necessary, the open system executes the second job step,
when a value of the match determination information is a value meaning that the current-new match determination has not been performed, the first current-new comparison section performs the current-new match determination and updates the value of the match determination information to a value meaning that the current-new match determination has been performed,
when the result of the current-new match determination is false, the process according to the result of the current-new match determination includes notification to a console of a failed second job step that is a second job step that belongs to a job step pair having caused the result of the current-new match determination to be false, and update of the value of the repair information to a value meaning that repair is necessary, and
when the failed second job step is repaired, the second current-new comparison section updates the match determination information to a value meaning that the current-new match determination has not been performed, and updates the value of the repair information to a value meaning that no repair is necessary.

7. The job migration support system according to claim 1,
wherein when the result of the current-new match determination is true, the process according to the result of the current-new match determination includes deletion of a job journal for a first job step that belongs to the job step pair and a job journal for a second job step that belongs to the job step pair.

8. A method for supporting migration of a first job executed by a mainframe system including a first check point restart (CPR) section to an open system,
wherein
a second CPR (check point restart) section is provided in the open system, which executes a second job that is the first job migrated to the open system,
the first job being formed of a plurality of first job steps,
the second job being formed of a plurality of second job steps respectively corresponding to the plurality of first job steps, and
for each of the first job steps, when restart is specified in the first job step, the mainframe system configured to output a job journal representing data manipulation in the first job step and a dataset on a data manipulation basis,
the method comprising:
for each of the second job steps, when restart is specified in the second job step, outputting, by the open system, a job journal representing data manipulation in the second job step and a dataset on a data manipulation basis,
for each of job step pairs that are pairs of the corresponding first job step and second job step in each of which the restart is specified,
performing, by the mainframe system or the open system, current-new match determination that is determination of whether or not the job journals for the first job step and the second job step coincide with each other and
carrying out, by the mainframe system or the open system, a process according to a result of the current-new match determination.

9. The job migration support method according to claim 8,
wherein when the result of the current-new match determination is false,
the process according to the result of the current-new match determination contains notifying the second CPR section of a failed second job step that is a second job step that belongs to the job step pair, and
the mainframe system or the open system restores a dataset as a state before start of the second job step based on a job journal for the failed second job step.

10. The job migration support method according to claim 9,
wherein when the result of the current-new match determination is false,
the open system acquires a job journal at start of a first job step following a first job step corresponding to the failed second job step,
the open system constructs a dataset as the state at start of a second job step corresponding to the following first job step and following the failed second job step based on the acquired job journal and the restored dataset, and
the open system initiates the following second job step based on the constructed dataset.

11. The job migration support method according to claim 10,
when a duplicate of data that the first job refers to in the mainframe system is inputted in the open system and the first job in the mainframe system and the second job in the open system are executed in parallel, on a job step pair basis,
when the open system acquires a job journal for a second job step that belongs to the job step pair, the open system notifies the mainframe system of start of execution of the second job step,
the mainframe system acquires a job journal for a first job step that belongs to the job step pair and waits for start of the execution of the first job step, and
the mainframe system initiates execution of the first job step that belongs to the job step pair when the mainframe system receives notification of the start of execution of the second job step.

12. The job migration support method according to claim 8,
wherein a storage space shared by the mainframe system and the open system stores on a job step pair basis repair information that is information representing whether or not a second job step that belongs to the job step pair needs to be repaired, and match determination information that is information representing whether or not the current-new match determination has been performed.

13. The job migration support method according to claim 12,
wherein on a job step pair basis,
when a value of the repair information is a value meaning that no repair is necessary, the open system executes the second job step,
when a value of the match determination information is a value meaning that the current-new match determination has not been performed, the mainframe system or the open system performs the current-new match determination and updates the value of the match determination information to a value meaning that the current-new match determination has been performed,
when the result of the current-new match determination is false, the process according to the result of the current-new match determination includes notification to a console of a failed second job step that is a second job step that belongs to a job step pair having caused the result of the current-new match determination to be false, and update of the value of the repair information to a value meaning that repair is necessary, and
when the failed second job step is repaired, the open system updates the match determination information to a value meaning that the current-new match determination has not been performed, and updates the value of the repair information to a value meaning that no repair is necessary.

14. The job migration support method according to claim 8,
wherein when the result of the current-new match determination is true, the process according to the result of the current-new match determination includes deletion of a job journal for a first job step that belongs to the job step pair and a job journal for a second job step that belongs to the job step pair.
